(19) United States
(12) Patent Application Publication
(10) Pub. No.: US 2007/0054182 A1
(43) Pub. Date: Mar. 8, 2007

(54) Timed-released activator pellet for lead-acid battery

(76) Inventor: Akiya Kozawa, Alchi-ken (JP)

Correspondence Address: Cornelius F. O'Brien, 30 Rural Drive, New Canaan, CT, 06840, US

(21) Appl. No.: 11/502,714

(22) Filed: Aug. 14, 2006

(30) Foreign Application Priority Data
Sep. 8, 2005 (JP) 2005-296897

(51) Int. Cl. H01M 6/30

(52) U.S. Cl. 429/110; 429/52

(57) ABSTRACT

A timed-release acid dissoluble organic polymer pellet for use as an additive in an acid electrolyte of a lead-acid battery to prolong the life of the battery and a process of using the organic polymer pellet in a lead-acid battery.

### FIELD OF THE INVENTION

A timed-release acid dissoluble organic polymer pellet adapted to be used in an acid electrolyte of a lead storage battery for the purpose of prolonging the life of the battery.

### BACKGROUND OF THE INVENTION

Lead-acid batteries are being widely used for cars, trucks, buses, forklifts, golf carts and the like. The lead-acid batteries can also be used for solar power generated electricity storage and in hybrid cars in the near future. The total use of this type of battery could soon be extremely large and could pose an environment problem. Therefore, it is desirable to recycle these batteries and extend their service life. However, the recharging of these batteries is costly and not completely effective.

It is an important object of the invention to prolong the life of a lead-acid battery by providing a timed-release acid dissoluble palletized organic polymer additive to the acid electrolyte of the battery.

It is another object of the invention to provide a process for charging a used lead-acid battery to prolong its use life by adding a novel timed-release acid dissoluble palletized organic polymer additive to the acid electrolyte of the lead-acid storage battery.

It is another object of the invention to recover deteriorated lead-storage batteries and extend their useful lifetime by adding a novel palletized organic polymer, such as polyvinyl alcohol, polyacrylic ester, polyacrylic acid, lignin, silver, indium salt, germanium compound, etc., which will increase the hydrogen over voltage of the negative electrode and effectively charge the negative electrode resulting in the recovery of the battery's Ahr capacity.

### SUMMARY OF THE INVENTION

In one embodiment of the invention a timed-release acid dissoluble organic polymer pellet is adapted to be placed in an acid electrolyte of a lead storage battery so that the organic polymer can be dissolved at a controlled rate and thereby increase the hydrogen over voltage of the negative electrode of the battery. The organic polymer is then gradually oxidized at the positive electrode. Preferably, a timed-release acid dissoluble organic polymer pellet should be added to the acid electrolyte when needed in order to maintain the battery performance.

Preferably, the organic polymer is packed in a outer capsule that has a controlled diffusion means, such as, at least one small hole. This will permit the acid electrolyte to diffuse into the capsule and dissolve the organic polymer and then the dissolved organic polymer material so formed can be transported out of the capsule. The organic polymer material dissolves into the acid and increases the hydrogen over voltage of the negative electrode. The outer capsule allows the organic polymer material to dissolve (diffuse) through the capsule. The open diffusion preferably, is accomplished by the presence of many holes 0.1 mm or less diameter or the open diffusion holes are sized 0.1 to 8 mm diameter in the capsule, or the diffusion should be through many fibers or the porosity of the material of the capsule could be suitably made to control the diffusion rate. The activator pellet should preferably comprise an easily dissoluble polymer or slowly dissolving polymer or the organic polymer should be a blended mixture of an easily dissoluble polymer and the slowly dissolving polymer so that a selected amount of the easily dissoluble polymer can provide an effective immediate increase in the hydrogen over voltage of the negative electrode. The slowly dissolving polymer in the mixture should then provide a control rate of the dissolved polymer over a longer time period.

Another embodiment of the invention is a process of extending the life of a lead-acid battery containing an acid electrolyte such as sulfuric acid, comprising the following steps:

a) adding to an acid electrolyte of a lead-acid storage battery at least one palletized organic polymer enclosed in a capsule having diffusion means sufficient to provide a controllable rate of the acid electrolyte to contact and controllably dissolve the organic polymer; and

b) discharging the acid-lead storage battery at an effective rate and time period such that the dissolving organic polymer shall continue at a controllable rate to effectively increase the hydrogen over voltage of the negative electrode of the battery.

The discharging rate could be the normal rate for starting an automobile and running the automobile for an average of four hours a day for a full year. The organic polymer pellet is designed to preferably last for at least six months and more preferably at least a full year. The size of the organic polymer pellet will depend on the vehicle's size battery such as batteries for cars, trucks, buses, forklifts, golf carts and the like.

Another embodiment, although not shown in the drawings, would comprise placing organic polymer (powder pellet or aqueous solution) in a small acid-resistant bag, preferably a flat bag, and having at least one hole to permit the acid electrolyte to controllably penetrate into the bag and thereby provide a controllable diffusion for the organic polymer.

Another embodiment of the invention is to formulate the organic polymer with a blend of an erodible controlled-release solid filler to produce a compacted pellet such as a tablet or pill. The term controlled-release is intended to refer to a formulation in which release of the active substance, such as organic polymer, is not immediate. The technology in the field of controlled-release formulations is well known, such as U.S. Pat. No. 6,673,369 and No. 5,300,300 and U.S. Patent Application No. 20060027007 and No. 20050181044. The controlled-release pellet could comprise a center core of the organic polymer coated with an erodible outer layer having a thickness depending on the timed-release rate desired.

If a battery becomes unable to provide an effective charge (“dead battery”), then the battery should be charged to restore life to the battery. In this case the following step should be performed after step a) and before step b) of the process:

aa) charging the battery at a rate of at least 0.3C for a time period of at least five minutes.

For a new charged battery, the organic polymer pellet can be added directly to the acid electrolyte and the discharging step b) can be done immediately. For sealed batteries, the organic polymer pellet could be added to the acid electrolyte before sealing the battery.

The polymer material could be blended with water and the mixture pressed or molded into a body with or without heat. Preferably, the outer capsule case material is made of a plastic which does not dissolve in the battery electrolyte. The organic polymer is preferably at least one of the group consisting essentially of polyvinyl alcohol, polyacrylic acid, polyacrylic ester, lignin, silver, indium salt, and germanium compound.

The organic polymer, which increases the hydrogen over voltage upon charge produces a very fine active material in the negative electrode in the lead storage battery containing dilute sulfuric acid. This fine active material in the negative electrode is far more active than the active lead powder made by ball milling. This new fine highly active material is produced in the presence of the organic polymer in the acid electrolyte.

It is preferable that the organic polymer be added in an amount of 0.001% to 0.5% by weight in the acid electrolyte solution of the battery. It is not preferable to add a large amount of the organic polymer in the acid electrolyte at one time, since when the battery is charged, gas and foam are produced. Therefore, the acid flows out with the generated form. Also, when the activator (organic polymer) is added in a large amount at one time, it is gradually oxidized at the positive electrode and the good effect will disappear in one or two years. It is preferable to slowly add this organic polymer to supply the amount lost by oxidation at the positive electrode.

In this invention, the organic polymer is allowed to slowly dissolve out through the capsule after the acid electrolyte is absorbed in the polymer in the capsule. The organic polymer absorbs the acid and becomes a gel. The gel will slowly dissolve out from the capsule over a long period of time. Thus the effective polymer concentration is maintained for a long period of time. This slow and gradual supply of the organic polymer takes place as described above. Therefore, when the capsule having controllably diffusing means and containing the organic polymer used in a lead storage battery, the life of the lead-acid battery could effectively be extended 5-10 years.

Organic polymers described in this invention are dissolved in the acid electrolyte, and preferably, very soluble and slightly soluble organic polymers are used together in the capsule in order to have a one-time addition operation. The very soluble organic polymers will dissolve quickly to provide initial high increase hydrogen over voltage followed by the slightly dissoluble organic polymers to provide a slower rate in increasing the hydrogen over voltage. The organic polymer includes at least one of the following: polyvinyl alcohol, polyacrylic acid, polyacrylic ester, lignin, silver, indium salt, germanium compounds, etc.

The outer capsule case could be made of sulfuric acid resistant material such as polyethylene, polypropylene, fluorine resin plastics, or glass. Preferably, the organic polymer could be a powder that can be pre-molded and then placed in an outer plastic capsule, or the powder or gel is blended with water to produce a hard bar that can be easily placed in the plastic capsule.

The diffusion means of the capsule is preferably controlled in this invention by the size of the small holes having a diameter between 0.1 mm and about 0.3 mm. Many of the holes in the capsule should have a diameter of less than 0.1 mm.

### BRIEF DESCRIPTION OF THE DRAWINGS

FIG. 1 is a cross-section view of an organic polymer enclosed in a capsule in accordance with the subject invention.

FIG. 2 is a cross-section view of another embodiment of an organic polymer enclosed in a capsule in accordance with the subject invention.

FIG. 3 is a cross-section view of an organic polymer enclosed in a plastic film in accordance with the subject invention.

FIG. 4 is a cross-section view of another embodiment of an organic polymer enclosed in plastic film in accordance with the subject invention.

FIG. 5 is a cross-section view of an organic polymer enclosed in a plastic capsule in accordance with the subject invention.

FIG. 6 is a cross-section view of glass fibers in an organic polymer enclosed in a plastic capsule in accordance with the subject invention.

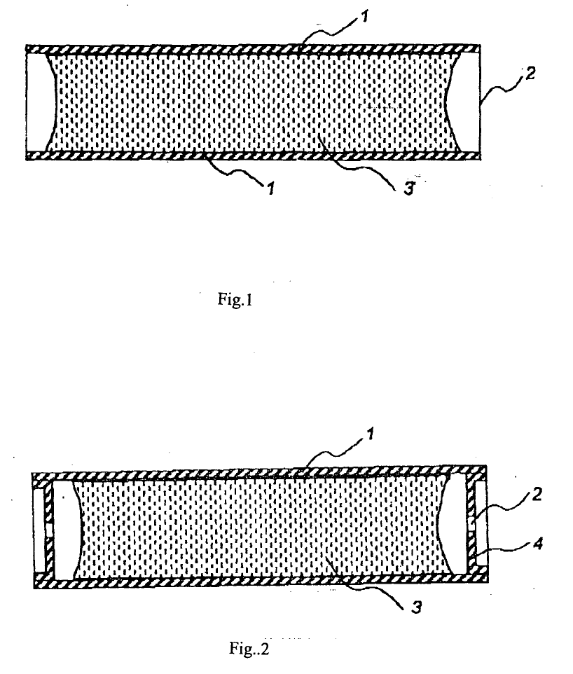

FIG. 1 is a plastic or glass pellet 1 having organic polymer(s) 3 inside the outer capsule 1 having a hole 2 at its ends. The size of the outer capsule 1 is preferably 1 to 3 mm diameter and 0.5 to 50 mm in length. The diffusion rate can be adjusted by selecting the diameter size of the capsule 1 and the distance between the undissolved polymer and the opening 2 of the pellet. This type of pellet is easy to produce, but the diffusion rate will change (become slower) as the polymer diffuses out.

FIG. 2 shows capsule 1 that can make a polymer 3 diffusion rate more constant compared to that of the FIG. 1 capsule, by adding edge plates 4 having hole 2. Multiple holes can be made in the edge plates 4.

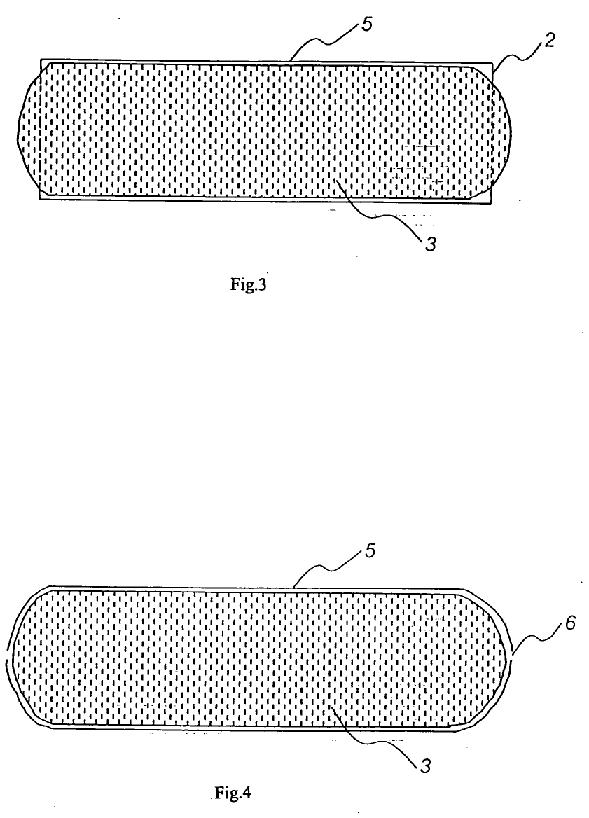

The capsule pellet in FIG. 3 is similar to FIG. 1. and easy to make. This is made of a blended polymer powder with water 3 and covering the surface with a plastic film 5 having opening 2 or a blended polymer bar should be coated with an organic solvent containing a capsule material and dried.

In FIG. 4 the entire surface of an organic polymer 3 is covered with an acid-resistant film 5 and then a proper hole size 6 is produced as the diffusion control means.

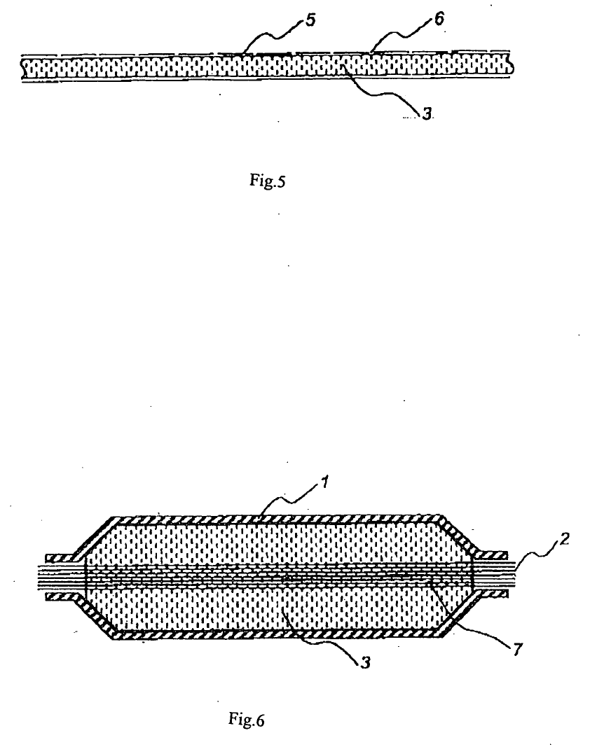

FIG. 5 shows a palletized organic polymer that is made of a blended organic polymer powder with a small amount of water 3, or molten organic polymer with heat, having an acid-resistant plastic 5 covering the blended or molten material 3. The small holes 6 are then made on the cover capsule 5 surface. This embodiment is preferably suitable for sealed batteries for which the flowable electrolyte is small.

FIG. 6 shows an activator capsule 1 having a bundle of glass fibers 7 in the activator polymer 3. In some cases at least one glass fiber could be in the organic polymer. The space between the glass fibers is preferably less than 0.1 mm. After the glass fibers are inserted into the polymer powder and placed into the capsule, it is heated to seal the two edges. The end of fibers 7 provides opening 2 to provide secure dissolution supply of the activator. This type of capsule is easy to absorb the acid electrolyte in the activator polymer material.

It is to be understood that modification and changes to the preferred embodiment of the invention herein can be made without departing from the spirit and scope of the invention.

What is claimed:

1. A battery activator pellet comprising a timed-release acid dissoluble organic polymer encased within an outer casing that has a dissolution rate controlling means adapted to permit a controlled rate of an acid electrolyte solution to diffuse into the casing to contact and controllably dissolve the organic polymer and adapted in such a way that the dissolved organic polymer material so formed can be diffused from the casing.

2. The battery activator pellet of claim 1 wherein the dissolution rate controlling means comprises at least one hole.

3. The battery activator pellet of claim 2 wherein the diameter of the at least one hole is 3.0 mm or less.

4. The battery activator pellet of claim 1 wherein the organic polymer is made from a material selected from at least one of the group consisting essentially of polyvinyl alcohol, polyacrylic ester, polyacrylic acid, lignin, silver, indium salt, and germanium compound.

5. The battery activator pellet of claim 1 wherein the casing is a material selected from the group consisting of plastic, glass and acid-resistant film.

6. The battery activator pellet of claim 5 wherein the acid-resistant film has a porosity adapted to permit an acid electrolyte solution to controllably diffuse through the film to contact and controllably dissolve the organic polymer and adapted such that the dissolved organic polymer material so formed can be timed-release diffused through the film.

7. The battery activator pellet of claim 3 wherein the diameter of the at least one hole is 0.1 mm or less.

8. The battery activator pellet of claim 1 wherein the organic polymer is a blend of a first acid dissoluble organic polymer with at least one additional acid dissoluble organic polymer having a dissolution rate different from the first acid dissoluble organic polymer.

9. The battery activator pellet claim 1 wherein the organic polymer is blended with water.

10. The battery activator pellet of claim 1 wherein the organic polymer is a powder

11. The battery activator pellet of claim 1 wherein the organic polymer is a compressed powder or heat melted powders.

12. The battery activator pellet of claim 1 wherein the organic polymer is selected from at least one of the group consisting essentially of polyvinyl alcohol and polyacrylic ester.

13. The battery activator pellet of claim 1 wherein at least one glass fiber is embedded within the organic polymer.

14. The battery activator pellet of claim 1 wherein the timed-release acid dissoluble organic polymer pellet is assembled in an acid electrolyte of a lead-acid storage battery.

15. The battery activator pellet of claim 14 wherein the organic polymer is a blend of a first acid dissoluble organic polymer with at least one additional acid dissoluble organic polymer having a dissolution rate different from the first acid dissoluble organic polymer.

16. A battery activator controlled-release solid pellet comprised of an organic polymer and an erodible filler adapted to permit a controlled rate of an acid electrolyte solution to controllably erode the filler and thereby controllably dissolve the organic polymer.

17. The battery activator controlled-release solid pellet of claim 16 wherein the organic polymer is made from a material selected from at least one of the group consisting essentially of polyvinyl alcohol, polyacrylic ester, polyacrylic acid, lignin, silver, indium salt, and germanium compound.

18. The battery activator of claim 16 wherein the pellet comprises a core of the organic polymer coated with a layer of the erodible filler.

19. A process for extending the life of an acid-lead storage battery comprising:
a) adding to an acid electrolyte of an acid-lead storage battery a time-released palletized organic polymer enclosed in a casing having diffusion means sufficient to provide a controllable rate of the acid electrolyte to contact and controllably dissolve the organic polymer; and
b) discharging the acid-lead storage battery at an effective rate and time period such that the time-released dissolved organic polymer will controllably exit from the casing and thereby provide a controllable rate increase in the hydrogen over voltage of the negative electrode of the battery.

20. The process of claim 19 wherein after steps a) and before steps b) the following step is added:
aa) charging the acid-lead storage battery at a rate of at least 0.3C for a time period of at least five minutes.
